(19) United States
(12) Patent Application Publication
(10) Pub. No.: US 2025/0372850 A1
(43) Pub. Date: Dec. 4, 2025

(54) LIQUID INJECTION DEVICE

(71) Applicant: SK ON CO., LTD., Seoul (KR)

(72) Inventor: Jun Hui JEONG, Daejeon (KR)

(21) Appl. No.: 19/220,104

(22) Filed: May 28, 2025

(30) Foreign Application Priority Data
May 29, 2024 (KR) 10-2024-0070124

(51) Int. Cl. H01M 50/618; H01M 50/107; H01M 50/167; H01M 50/627

(52) U.S. Cl. CPC H01M 50/618; H01M 50/167; H01M 50/627; H01M 50/107

(57) ABSTRACT

A liquid injection device according to an exemplary embodiment of the present disclosure is a liquid injection device for injecting an electrolyte into a battery case of a secondary battery, which includes: a nozzle member having a closed-loop shape and disposed in the injection port of the battery case; and a main rib extending from the nozzle member toward a central part of the nozzle member to support the nozzle member, and the nozzle member may press the inner surface of the battery case outward in a radial direction.

### CROSS-REFERENCE TO RELATED APPLICATION

This patent application claims the priority and benefits of Korean patent application No. 10-2024-0070124, filed on May 29, 2024, the disclosure of which is incorporated herein by reference in its entirety.

### BACKGROUND

### 1. Field of the Invention

The present disclosure relates to a liquid injection device.

### 2. Description of the Related Art

Secondary batteries are used as energy sources in electric vehicles or electronic devices. In the secondary battery, a jelly-roll-type electrode assembly, in which an anode plate, a cathode plate, and separators are wound together, is used, or alternatively, an electrode assembly fabricated by stacking an anode plate, a cathode plate, and a separator in an appropriate order may be used.

This electrode assembly is accommodated in a housing and connected to an anode terminal and a cathode terminal. The housing is then sealed after being filled with an electrolyte.

SUMMARY According to an aspect of the present disclosure, there may be provided a liquid injection device which is capable of, when injecting an electrolyte into a battery case of a secondary battery, improving sealing performance and preventing deformation of the battery case during the electrolyte injection.

To achieve the above object, the following technical solutions are proposed in the present disclosure.

A liquid injection device configured to inject an electrolyte into a battery case of a secondary battery according to an exemplary embodiment of the present disclosure, the liquid injection device includes: a nozzle member having a closed-loop shape and disposed in the injection port of the battery case; and a main rib extending from the nozzle member toward a central part of the nozzle member to support the nozzle member, wherein the nozzle member may be configured to press the inner surface of the battery case outward in a radial direction.

In an exemplary embodiment, the nozzle member may closely support the inner surface of the battery case outward in the radial direction.

In an exemplary embodiment, the nozzle member may be located above a beading part of the battery case.

In an exemplary embodiment, the nozzle member may be disposed at a position corresponding to a crimping part of the battery case.

In an exemplary embodiment, the nozzle member may be located above an electrode assembly disposed inside the battery case.

In an exemplary embodiment, the nozzle member may include an elastic material.

In an exemplary embodiment, the liquid injection device may further include an elevating member disposed to move up and down at the central part of the nozzle member, wherein a longitudinal inner end of the main rib is configured to move along an outer circumferential surface of the elevating member.

In an exemplary embodiment, the main rib may apply a pressing force to the nozzle member by changing its angle with respect to the nozzle member.

In an exemplary embodiment, the liquid injection device may further include an auxiliary rib connecting the elevating member and the main rib, wherein the longitudinal inner end of the auxiliary rib is connected to the elevating member, and a longitudinal outer end of the auxiliary rib is connected to the main rib.

In an exemplary embodiment, the liquid injection device may further include a bushing member connected to the longitudinal inner end of the main rib to guide a vertical movement of the elevating member.

In an exemplary embodiment, the longitudinal inner end of the main rib may be fixed to one side of the elevating member through the bushing member.

In an exemplary embodiment, the elevating member may have a columnar shape extending in the axial direction.

In an exemplary embodiment, the main rib may apply a pressing force to the nozzle member by shifting its position in the radial direction.

In an exemplary embodiment, the elevating member may be formed in a conical shape.

In an exemplary embodiment, the liquid injection device may further include a diameter-regulating member connected to the inner end of the main rib and having a diameter which is adjusted in response to the vertical movement of the elevating member.

In an exemplary embodiment, the length of the main rib may be adjustable in the radial direction.

In an exemplary embodiment, the nozzle member may have a tube shape configured to inject a fluid, and the nozzle member expands in volume in response to the injection of the fluid to press the inner surface of the battery case.

In an exemplary embodiment, the liquid injection device may further include a fluid injection port disposed on one side of the nozzle member through which the fluid is injected.

In an exemplary embodiment, the liquid injection device may further include a support plate disposed along an inner circumference of the nozzle member between the nozzle member and the main rib.

In an exemplary embodiment, a plurality of support plates may be provided, and the plurality of support plates may be spaced apart from one another as the nozzle member presses the inner wall of the battery case.

The liquid injection device according to various embodiments of the present disclosure may improve the sealing force inside the battery case during the electrolyte injection.

In addition, the liquid injection device according to various embodiments of the present disclosure may prevent the deformation of the battery case during the electrolyte injection.

Further, the liquid injection device according to various embodiments of the present disclosure may prevent the deformation of the battery case, thereby facilitating the securing of the external design dimensions of the final cell.

Furthermore, the liquid injection device according to various embodiments of the present disclosure may minimize the external force applied to the beading part of the battery case during the electrolyte injection process, thereby minimizing the influence on the subsequent crimping process and stabilizing the manufacturing process of the secondary battery.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a cross-sectional view schematically illustrating a secondary battery to which a liquid injection device according to an exemplary embodiment of the present disclosure may be applied;

FIG. 2 is a cross-sectional view schematically illustrating a pressurized state of a battery case caused by the liquid injection device according to an exemplary embodiment of the present disclosure;

FIG. 3 is a plan view schematically illustrating the state in FIG. 2 as viewed from above;

FIG. 4 is a cross-sectional view schematically illustrating a pressing process of the battery case by the liquid injection device according to an exemplary embodiment of the present disclosure;

FIG. 5 is a cross-sectional view schematically illustrating a pressing process of the battery case by the liquid injection device according to an exemplary embodiment of the present disclosure;

FIG. 6 is a plan view schematically illustrating the pressing process shown in FIG. 5 as viewed from above;

FIG. 7 is a plan view schematically illustrating a pressurized state of the battery case caused by the liquid injection device according to an exemplary embodiment of the present disclosure as viewed from above;

FIG. 8 is a plan view schematically illustrating the pressurized state of the battery case caused by the liquid injection device according to an exemplary embodiment of the present disclosure as viewed from above; and

FIG. 9 is a plan view schematically illustrating the pressurized state of the battery case caused by the liquid injection device according to an exemplary embodiment of the present disclosure as viewed from above.

### DETAILED DESCRIPTION OF THE INVENTION

As used herein, the singular form may include the plural form unless the context clearly dictates otherwise.

In addition, when used to describe and define the present disclosure, terms such as “comprise,” “include,” “consist of,” and “have” should be interpreted in a non-exclusive manner. Unless explicitly stated otherwise, these terms should be construed to imply the presence of the corresponding component, and therefore should not be interpreted as excluding the presence of other components, but rather as including them.

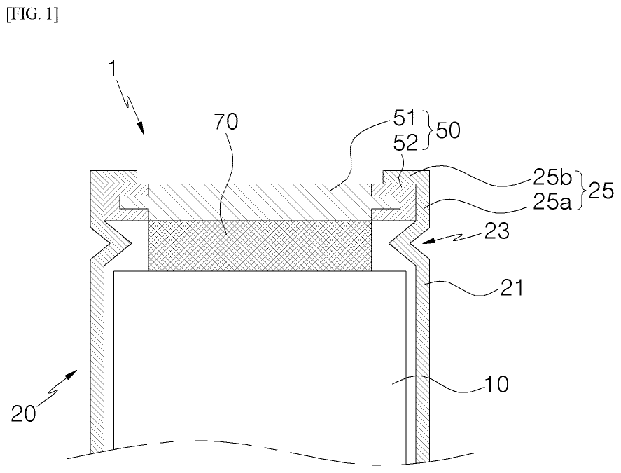

Hereinafter, the present disclosure will be described in detail with reference to FIGS. 1 to 9. However, these are merely illustrative, and the present disclosure is not limited to the specific embodiments described as examples.

It should be understood that the accompanying drawings schematically illustrate the features of the present disclosure and may be reduced or enlarged relative to actual dimensions, and may be exaggerated or partially omitted for clarity.

A secondary battery 1 described in the present disclosure may be any type of conventional battery cell capable of converting chemical energy stored in the battery into electrical energy, and capable of repeated charging and discharging.

In describing various embodiments of the present disclosure, the axial direction may refer to a direction parallel to the direction in which a central axis extends, along which a jelly-roll-type electrode assembly 10 is wound, and the radial direction may refer to a direction extending toward or away from the central axis.

Meanwhile, since the central axis of a cylindrical battery case 20 and the central axis of the electrode assembly 10 are formed coaxially, the axial direction in the present disclosure may be understood as a direction parallel to the direction in which a central axis of the cylindrical battery case 20 extends, and the radial direction may be understood as a direction extending from the central axis of the cylindrical battery case 20 toward the side wall 21.

Hereinafter, the secondary battery 1 to which a liquid injection device 100 according to various embodiments of the present disclosure may be applied will be described by way of example with reference to FIG. 1. However, although a cylindrical secondary battery 1 is illustratively described herein, it will be apparent that the liquid injection device 100 of the present disclosure may be applied to any type of secondary battery 1 having an open injection port.

In addition, it should be understood that the internal components or arrangement structures of the secondary battery 1 to which the liquid injection device 100 of the present disclosure may be applied are not limited to the exemplary structures described below, and any internal component or arrangement structure apparent to those skilled in the art at the time of application may also be applied.

FIG. 1 is a cross-sectional view schematically illustrating the secondary battery 1 to which a liquid injection device 100 according to an exemplary embodiment of the present disclosure may be applied.

Referring to FIG. 1, the secondary battery 1 into which an electrolyte is injected by applying the liquid injection device 100 according to various embodiments of the present disclosure may include the battery case 20, the electrode assembly 10, and a cap assembly 50. In addition, in an exemplary embodiment, the secondary battery 1 may further include a first current collector 70, a second current collector (not shown), and/or an insulator (not shown).

The battery case 20 may exemplarily be formed in a cylindrical shape having an internal space. The battery case 20 may have an opening formed at one axial end, and the other axial end of the battery case 20 may be closed. Here, as shown in FIG. 1, an upper end of the battery case 20 is illustrated as being open, but the opposite configuration may also be employed.

The electrode assembly 10 and the electrolyte may be injected into the inside of the battery case 20 through the above-described opening. Hereinafter, the opening of the battery case 20 may be described as an injection port through which the electrolyte is injected. The battery case 20 may include a conductive metal material.

The battery case 20 may be electrically connected to either a first electrode plate (not shown) or a second electrode plate (not shown) of the electrode assembly 10. The battery case 20 may be connected to either the first electrode plate or the second electrode plate so as to have a corresponding polarity. For example, when the battery case 20 is electrically connected to the first electrode plate, the second electrode plate may be electrically insulated from the battery case 20 to prevent a short circuit. Likewise, when the battery case 20 is connected to the second electrode plate, the first electrode plate may be electrically insulated from the battery case 20 to prevent a short circuit.

The battery case 20 may include the opening formed at an upper axial end, a lower wall (not shown) formed at an axial end opposite to the opening, and a side wall 21 connecting the opening and the lower wall. In an exemplary embodiment, for example, the lower wall of the battery case 20 may have a flat shape.

The battery case 20 may include a crimping part 25 in which a partial section of the upper side wall 21 is bent inward while the cap assembly 50 is coupled thereto. For example, the crimping part 25 may refer to at least a partial section of the upper side wall 21 of the battery case 20 positioned above the beading part 23.

The crimping part 25 may be described as a section of the side wall 21 adjacent to the cap assembly 50 and surrounding the cap assembly 50. The crimping part 25 may include a section 25a that surrounds a side surface of the cap assembly 50, and a section 25b that is bent to surround an upper surface of the cap assembly 50.

In an exemplary embodiment, a beading part and/or a crimping part may not be formed in the side wall 21 of the battery case 20. The opening of the battery case 20 may be closed by the cap plate 51. In this case, the opening of the battery case 20 may be welded to the cap plate 51 along an upper periphery of the side wall 21.

The electrode assembly 10 may include the first electrode plate (not shown), the second electrode plate (not shown), and a separator (not shown).

The first electrode plate may be either a cathode plate or an anode plate. If the first electrode plate is a cathode plate, the second electrode plate may be an anode plate, and if the first electrode plate is an anode plate, the second electrode plate may be a cathode plate.

For example, the first electrode plate may be a cathode plate. In an exemplary embodiment, the first electrode plate may include a cathode current collector in the form of a metal foil and a cathode coating layer formed by applying a cathode active material to the cathode current collector. For example, the cathode current collector may include aluminum.

In an exemplary embodiment, the cathode coating layer may be an electrically conductive coating, and may include a cathode active material. For example, the cathode active material may include lithium nickel manganese cobalt oxide (NMC), lithium manganese oxide (LMO), lithium iron phosphate (LFP), lithium cobalt oxide (LCO), lithium titanate (LTO), or a chalcogenide compound (such as LiTiS₂), but it is not limited thereto, and any cathode active material known to those skilled in the art may be used.

In an exemplary embodiment, the first electrode plate may include a first coated part (not shown) on which a cathode coating layer is formed on the cathode current collector, and a first uncoated part (not shown), in which no cathode active material is formed on the cathode current collector.

The second electrode plate may be either a cathode plate or an anode plate. For example, the second electrode plate may be an anode plate. In an exemplary embodiment, the second electrode plate may include an anode current collector in the form of a metal foil and an anode coating layer formed by applying an anode active material to the anode current collector. For example, the anode current collector may include copper or nickel.

In an exemplary embodiment, the anode coating layer may be an electrically conductive coating, and may include an anode active material. For example, the anode active material may include a silicon material (e.g., metallic silicon and silicon dioxide), a carbon-based material (e.g., graphite materials, graphene-containing materials, hard carbon, soft carbon, carbon nanotubes, porous carbon, or conductive carbon), a tin-based material, or a metal oxide, but it is not limited thereto, and any anode active material known to those skilled in the art may be used.

In an exemplary embodiment, the second electrode plate may include a second coated part (not shown) on which an anode coating layer is formed on the anode current collector, and a second uncoated part (not shown), in which no anode coating layer is formed on the anode current collector.

The separator may be interposed between the first electrode plate and the second electrode plate to prevent the first electrode plate and the second electrode plate from being electrically connected to each other and causing a short circuit. In an exemplary embodiment, the separator may include an electrically insulating material. For example, the separator may include a polymeric material. For example, the separator may include polyethylene, polypropylene, or a combination thereof, but it is not limited thereto.

The electrode assembly 10 may be wound in a jelly-roll shape by stacking the above-described first electrode plate, the separator, and the second electrode plate. In an exemplary embodiment, the first uncoated part and the second uncoated part may be respectively exposed at opposite axial ends of the electrode assembly 10 to define electrode tabs.

In an exemplary embodiment, the electrode assembly 10 may be a tab-less type that utilizes the first uncoated part and the second uncoated part as electrode tabs. However, it is not limited thereto, and separate electrode tabs respectively connected to the above-described first and second electrode plates may be provided.

In an exemplary embodiment, the battery case 20 may be electrically connected to the second electrode plate. For example, the battery case 20 may be connected to the second electrode plate to serve as an anode terminal. The second electrode plate may be in direct contact with the lower wall or side wall 21 of the battery case 20 through the above-described second uncoated part. However, the second electrode plate may also be connected to the battery case 20 through the second current collector disposed between the second uncoated part and the battery case 20.

The cap assembly 50 may include a cap plate 51 and a sealing gasket 52. The cap assembly 50 may be coupled to the opening of the battery case 20 to close the opening and seal the battery case 20. The cap assembly 50 may be secured by the crimping part 25 of the battery case 20.

The cap plate 51 may be electrically connected to the first electrode plate of the electrode assembly 10. For example, the cap plate 51 may be made of a conductive metal material. The cap plate 51 may be connected to the first electrode plate to serve as a cathode terminal. The cap plate 51 may be in direct contact with the first uncoated part of the first electrode plate. However, it is not limited thereto, and the cap plate 51 may alternatively be connected to the first electrode plate through the first current collector 70 disposed between the cap plate 51 and the first uncoated part.

The cap plate 51 may be formed in a shape corresponding to the opening of the battery case 20. For example, the cap plate 51 may have a circular plate shape.

The cap plate 51 may seal the inside of the battery case 20 through the sealing gasket 52 disposed around its periphery. The cap plate 51 may be electrically insulated from the battery case 20 through the sealing gasket 52.

In an exemplary embodiment, the cap plate 51 may be directly coupled to the injection port of the battery case 20. The cap plate 51 may be coupled to the injection port of the battery case 20 by means of welding. In this case, the above-described cap assembly 50 may refer solely to the cap plate 51.

The sealing gasket 52 may be disposed at the periphery of the cap plate 51. The sealing gasket 52 may electrically insulate the cap plate 51 from the battery case 20. The sealing gasket 52 may include an insulating material. The sealing gasket 52 may be interposed between the cap plate 51 and the crimping part 25 of the battery case 20 to maintain airtightness. The sealing gasket 52 may be formed of an elastic material. For example, the sealing gasket 52 may be formed of a resin material such as polyethylene (PE), polypropylene (PP), polyethylene terephthalate (PET), or the like.

The first current collector 70 may be disposed between the electrode assembly 10 and the cap assembly 50. The first current collector 70 may electrically connect the first electrode plate of the electrode assembly 10 and the cap plate 51. The first current collector 70 may include a conductive material. The first current collector 70 may have any shape apparent to those skilled in the art.

In an exemplary embodiment, the secondary battery 1 to which the liquid injection device 100 of the present disclosure is applied may further include a second current collector plate and/or an insulator.

The second current collector plate may be disposed between the electrode assembly 10 and the lower wall of the battery case 20. For example, the second current collector plate may electrically connect the second electrode plate of the electrode assembly 10 to the battery case 20.

The insulator may be disposed between the battery case 20 and the first current collector 70 and/or between the battery case 20 and the first electrode plate to prevent electrical connection therebetween.

In various embodiments of the present disclosure, the cathode terminal and the anode terminal may be interchanged with each other in a switchable manner.

In the secondary battery 1 to which the liquid injection device 100 according to various embodiments of the present disclosure is applied, the electrode assembly 10 may be inserted through the opening of the battery case 20 during the manufacturing process.

For example, in the manufacturing process of the secondary battery 1, after the electrode assembly 10 is received inside the battery case 20, a beading part 23 may be formed by recessing a partial section of the side wall 21 of the battery case 20 inward toward the center. The battery case 20 may apply a physical fixing force to the electrode assembly 10 accommodated therein through the beading part 23. In another embodiment, a method for fixing the electrode assembly 10 through the arrangement of internal components of the electrode assembly 10 may also be applied to the secondary battery, without forming the beading part 23 in the battery case 20.

In the secondary battery 1, the electrolyte may be injected into the battery case 20 through the opening using the liquid injection device 100 according to various embodiments of the present disclosure during the liquid injection process. Here, the electrolyte serves to enable lithium ions to migrate between the first electrode plate and the second electrode plate forming the electrode assembly 10. For example, the electrolyte may be a non-aqueous organic electrolyte that is a mixture of a lithium salt and a high-purity organic solvent, but it is not limited thereto.

Thereafter, the secondary battery 1 may be formed with the crimping part 25 in which the open end of the battery case 20 is bent inward toward the center through a crimping process. The crimping part 25 may be described as being formed by inwardly bending a partial section of the lower side wall 21 of a battery can toward the center. In an exemplary embodiment, the crimping part 25 may be formed below the beading part 23.

In the secondary battery 1, the cap plate 51 is seated on the beading part 23 of the battery can together with the sealing gasket 52, and the crimping part 25 is formed, thereby preventing the detachment of the cap plate 51.

Meanwhile, the liquid injection process among the manufacturing processes of the secondary battery 1 is generally performed while the battery case 20 is in an open state. If the electrolyte is injected while air remains inside the battery case 20, swelling caused by gas generation or a decrease in battery performance may occur during charging and discharging of the battery. Therefore, during the liquid injection process, it is necessary to form a vacuum atmosphere inside the case before injecting the electrolyte and to maintain the vacuum atmosphere during the injection process.

That is, during the liquid injection process, it is very important to secure a sealing force between the injection port of the battery case 20 and the injection nozzle of the liquid injection device 100 in order to enhance the liquid injection performance.

In general, during the liquid injection process, an injection nozzle is seated on the beading part 23 of the battery case 20 or the injection nozzle is seated on the upper end of the opening of the battery case 20, and then downward pressure is applied to the injection nozzle, thereby improving the adhesion force between the battery case 20 and the injection nozzle and ensuring sealing force.

However, if the injection nozzle is seated on the beading part 23, since the beading part 23 is generally not flat, electrolyte leakage may occur between the injection nozzle and the beading part 23. In addition, if the injection nozzle is seated on the upper end of the opening of the battery case 20, electrolyte leakage may occur due to wear of the nozzle member.

In particular, in the above-described general methods, if a downward pressure is applied to the battery case 20 to improve the adhesion force between the battery case 20 and the injection nozzle, there is a very high possibility that the shape of the battery case 20 may be deformed, such as deformation of the beading part 23 or a change in the height of the battery case 20.

These problems may make vacuum control difficult, resulting in poor electrolyte injection, increased injection time, adverse effects on subsequent crimping processes, and an increased the defect rate of the product.

Various embodiments of the present disclosure may propose the liquid injection device 100 capable of preventing deformation of the battery case 20 and improving the adhesion force with the injection port of the battery case 20 during the liquid injection process of the secondary battery 1.

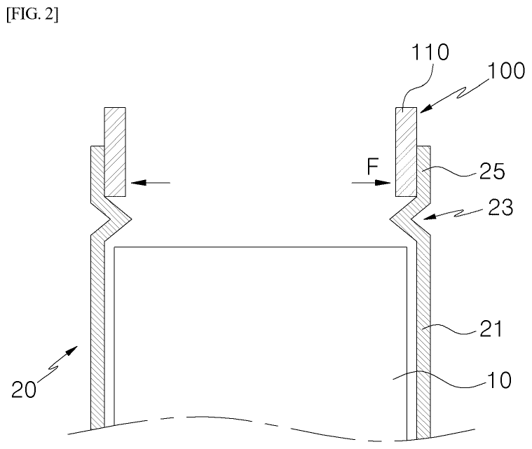

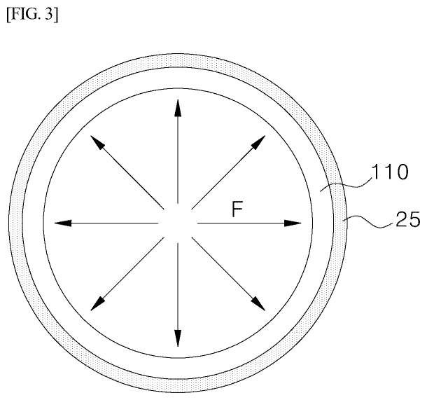

First, a method for securing a sealing force at the injection port of the battery case 20 through the liquid injection device 100 according to various embodiments of the present disclosure will be described with reference to FIGS. 2 and 3.

FIG. 2 is a cross-sectional view schematically illustrating a pressurized state of the battery case 20 caused by the liquid injection device 100 according to an exemplary embodiment of the present disclosure, and FIG. 3 is a plan view schematically illustrating the state in FIG. 2 as viewed from above.

Referring to FIGS. 2 and 3, the liquid injection device 100 according to various embodiments of the present disclosure may include a nozzle member 110 and a main rib 120.

The liquid injection device 100 according to various embodiments of the present disclosure may include the nozzle member 110, which has a closed-loop shape and is disposed in the injection port of the battery case 20, and the main rib 120, which extends from the nozzle member 110 toward a central part of the nozzle member 110 to support the nozzle member 110. The nozzle member 110 may press an inner surface of the battery case 20 outward in a radial direction.

Referring to FIG. 2, the liquid injection device 100 according to various embodiments of the present disclosure may be coupled to the injection port of the battery case 20, and may apply a radially outward pressing force to the inner surface of the battery case 20. For example, the liquid injection device 100 may be coupled to a region corresponding to the crimping part 25 of the battery case 20 to apply a pressing force.

Since the region corresponding to the crimping part 25 of the battery case 20 has a flat axial cross-section, the liquid injection device 100 of the present disclosure may improve the adhesion force by applying a radial pressing force.

In addition, referring to FIG. 3, the liquid injection device 100 of the present disclosure may apply a radially outward pressing force to the inner surface from the central part of the battery case 20, and may apply the force evenly along the circumference of the battery case 20.

That is, the liquid injection device 100 of the present disclosure may come into surface contact with an inner surface of the injection port along the entire circumference, thereby further improving the adhesion force.

Meanwhile, the liquid injection device 100 proposed in the present disclosure may not apply a downward pressing force to the battery case 20 during the process of securing the sealing force of the battery case 20. For example, the liquid injection device 100 may not exert a downward pressing force on the upper end of the battery case 20. For example, the liquid injection device 100 may not apply a downward pressing force to the beading part 23 of the battery case 20. Accordingly, the liquid injection device 100 may not cause wear on the upper end of the battery case 20, or may not cause deformation in the height or shape of the battery case 20. The liquid injection device 100 may also not cause deformation of the beading part 23 of the battery case 20.

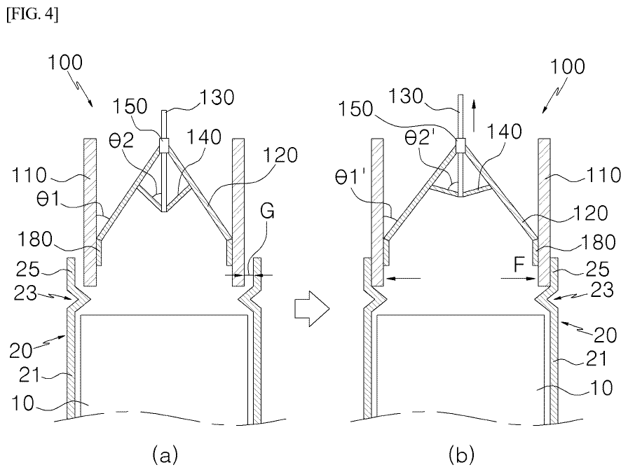

Hereinafter, the liquid injection device 100 according to an exemplary embodiment of the present disclosure will be described in more detail with reference to FIGS. 4 to 9.

First, FIG. 4 is a cross-sectional view schematically illustrating a pressing process of the battery case 20 by the liquid injection device 100 according to an exemplary embodiment of the present disclosure.

Referring to FIG. 4, the liquid injection device 100 according to an exemplary embodiment of the present disclosure may include the nozzle member 110, the main rib 120, and an elevating member 130. In addition, the liquid injection device 100 in the present embodiment may further include a bushing member 150.

In the exemplary embodiment, the liquid injection device 100 may be configured such that the main rib 120 applies a pressing force to the nozzle member 110 based on the principle of umbrella's unfolding.

The nozzle member 110 may be provided in a shape corresponding to the shape of the injection port of the battery case 20. For example, the nozzle member 110 may have a closed-loop shape corresponding to the shape of the injection port of the battery case 20. The nozzle member 110 may be disposed in the injection port of the battery case 20. The nozzle member 110 may be positioned adjacent to the inner surface of the injection port.

The nozzle member 110 may apply a radial pressing force to the inner surface of the battery case 20 by the main rib 120. The nozzle member 110 may press the inner surface of the battery case 20 outward in the radial direction. The nozzle member 110 may closely support the inner surface of the battery case 20 outward in the radial direction.

The nozzle member 110 may include an elastic material. The diameter of the nozzle member 110 may change as a radially outward pressing force is applied by the main rib 120. The nozzle member 110 may be elastically deformed to increase its diameter and come into close contact with the inner surface of the battery case 20. The nozzle member 110 may be elastically deformed between the main rib 120 and the inner surface of the battery case 20, thereby enhancing the adhesion force with the inner surface of the battery case 20.

The nozzle member 110 may be disposed at a position corresponding to the crimping part 25 of the battery case 20. The nozzle member 110 may apply a radially outward pressing force to at least a partial region of the crimping part 25 of the battery case 20. For example, the nozzle member 110 may be positioned above the beading part 23 of the battery case 20. The lower end of the nozzle member 110 may be disposed upwardly spaced from the beading part 23.

The nozzle member 110 may be positioned above the electrode assembly 10 inside the battery case 20. For example, the nozzle member 110 may be positioned above the electrode assembly 10 so as to be spaced apart from the electrode assembly 10 by a predetermined gap. The nozzle member 110 may apply a radially outward pressing force to at least a partial region of the inner surface of the injection port of the battery case 20 from above the electrode assembly 10. For example, the nozzle member 110 may apply a radially outward pressing force to at least a partial region of the inner surface of the injection port of the battery case 20 between the upper end of the battery case 20 and the electrode assembly 10. For example, the nozzle member 110 may apply a radially outward pressing force to a region spaced apart from the upper end of the battery case 20 by a predetermined gap. In this case, the beading part 23 and/or the crimping part 25 of the battery case 20 may be omitted.

Since the crimping part 25 of the battery case 20, where the nozzle member 110 is disposed, is a portion that is bent and deformed inward in the radial direction during the crimping process, even if a radial outward pressing force is applied through the liquid injection device 100 of the present disclosure, deformation of the battery case 20 may be minimized.

In addition, since the nozzle member 110 is located above the beading part 23, it may not apply a downward pressing force or a radial outward pressing force to the beading part 23, and deformation of the beading part 23 may be prevented during the liquid injection process.

Further, since the nozzle member 110 does not apply a downward pressing force to the upper end portion of the battery case 20 even when the beading part 23 and/or the crimping part 25 are omitted from the battery case 20 and the cap plate 51 is directly coupled to the injection port of the battery case 20, wear or deformation at the upper end portion of the battery case 20 may be prevented.

The liquid injection device 100 may include the main rib 120. The main rib 120 may be disposed at a position corresponding to the crimping part 25 of the battery case 20. The main rib 120 may be positioned radially inward of the nozzle member 110 to support the nozzle member 110.

The main rib 120 may apply a radially outward pressing force to the nozzle member 110 so that the nozzle member 110 can press the inner surface of the battery case 20. In an exemplary embodiment, the main rib 120 may apply a pressing force to the nozzle member 110 by changing its angle with respect to the nozzle member 110.

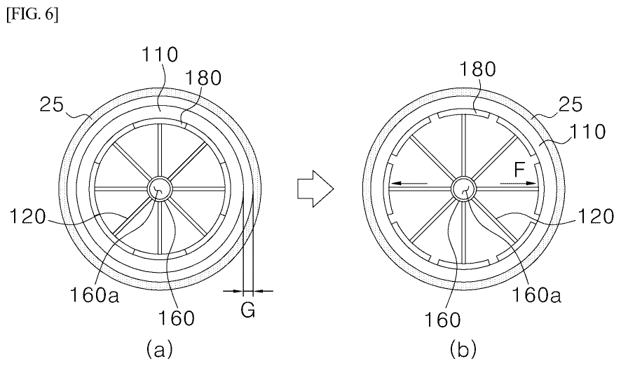

The main rib 120 may extend radially inward from the closed-loop-shaped nozzle member 110. A plurality of main ribs 120 may be provided. For example, eight main ribs 120 may be provided (e.g. FIG. 6), but it is not limited thereto.

The plurality of main ribs 120 may be radially disposed inside the nozzle member 110. Each main rib 120 may be formed to extend to a predetermined length. For example, as shown in FIG. 4, when viewed from the side surface of the secondary battery 1, each main rib 120 may be disposed at an incline such that the inner longitudinal end is located higher than the outer end.

Referring to FIG. 4, in an exemplary embodiment, the liquid injection device 100 may include the elevating member 130. The elevating member 130 may be positioned at a central part of the main ribs 120 which are disposed radially. The elevating member 130 may be configured to move up and down by an actuator (not shown).

The liquid injection device 100 may include the elevating member that is disposed so as to be able to move up and down at the central part of the nozzle member 110, and the longitudinal inner end of the main rib 120 may move along an outer circumferential surface of the elevating member 130.

For example, the elevating member 130 may have a columnar shape extending in the axial direction. In this case, the longitudinal outer end of the main rib 120 may be connected to the nozzle member 110, and the inner end may be connected to the elevating member 130 disposed at the central part. The elevating member 130 may move up and down in the axial direction, parallel to the central part of the main rib 120, thereby allowing the main rib 120 to apply a radially outward pressing force to the nozzle member 110.

In an exemplary embodiment, the liquid injection device 100 may further include auxiliary ribs 140 that extend to a predetermined length so as to connect the elevating member 130 and the main ribs 120. The auxiliary ribs 140 may be provided in a number corresponding to the number of main ribs 120. A longitudinal inner end of each auxiliary rib 140 may be connected to the elevating member 130, and an outer end may be connected to the main rib 120. For example, the outer end of the auxiliary rib 140 may be connected between the inner end and the outer end of the main rib 120.

In an exemplary embodiment, the liquid injection device 100 may further include the bushing member 150 connected to the longitudinal inner end of the main rib 120 to guide the vertical movement of the elevating member 130. For example, the bushing member 150 may be provided in a hollow cylindrical shape, and the elevating member 130 may move up and down through the hollow portion of the bushing member 150.

The inner end of the main rib 120 may be fixed to one side of the elevating member 130 through the bushing member 150. For example, the bushing member 150 may be fixed to a specific height of the elevating member 130 while the elevating member 130 is in an elevated position.

A method for bringing the nozzle member 110 into close contact with the inner surface of the battery case 20 through the main rib 120 during the operation of the liquid injection device 100 according to an exemplary embodiment will be described in detail with reference to FIG. 4. First, FIG. 4(a) is a view illustrating an initial state before the liquid injection nozzle is brought into close contact with the battery case 20 in an exemplary embodiment, and FIG. 4(b) is a view illustrating a state where the liquid injection device 100 is operated and the liquid injection nozzle comes into close contact with the inner surface of the battery case 20.

Referring to FIG. 4(a), in the initial state, the liquid injection device 100 may be inserted into the injection port of the battery case 20 at the beginning of the liquid injection process. The nozzle member 110 may be positioned at a location where at least a partial section corresponds to the crimping part 25 of the battery case 20. However, it is not limited thereto, and the nozzle member 110 may be positioned above the beading part 23. Alternatively, a lower end portion of the nozzle member 110 may be positioned at the same height as an upper end portion of the beading part 23, but it should be noted that, in the present disclosure, the nozzle member 110 does not apply a downward pressure on the beading part 23.

In this case, the nozzle member 110 may be positioned with an outer diameter smaller than the inner diameter of the injection port so as to be easily inserted into the injection port. The nozzle member 110 may be positioned with a predetermined gap G from the inner surface of the injection port. In addition, when viewed from the side surface of the secondary battery 1, the main rib 120 may be disposed to have a first angle θ1 with respect to the nozzle member 110, and the auxiliary rib 140 may be disposed to have a second angle θ2 with respect to the elevating member 130.

Thereafter, as shown in FIG. 4(b), when the liquid injection device 100 operates and the elevating member 130 is raised, the inner end of the auxiliary rib 140 may be pulled up by the elevating member 130, and the main rib 120 may be unfolded based on the elevating member 130. The operation is based on the well-known principle of unfolding umbrella ribs.

In this case, the first angle θ1′, formed by the main rib 120 with respect to the nozzle member 110, may increase compared to the initial state and may become less than or equal to 90 degrees. In addition, the second angle θ2′, formed by the auxiliary rib 140 with respect to the elevating member 130, may also increase compared to the initial state and may become less than or equal to 90 degrees. In this process, the outer end of the main rib 120 may apply a pressing force to the nozzle member 110 outward in the radial direction from the central part.

Meanwhile, when a pressing force is applied to the nozzle member 110 by the main rib 120, the nozzle member 110 may be elastically deformed in a direction that increases its diameter.

The nozzle member 110 may be elastically deformed to have a diameter corresponding to the diameter of the injection port of the battery case 20, thereby coming into close contact with the inner surface of the battery case 20. Once in contact with the inner surface of the battery case 20, the nozzle member 110 may be further elastically compressed as the elevating member 130 moves upward, thereby enhancing the sealing engagement with the inner surface of the battery case 20.

In the manufacturing process of the secondary battery 1, when the nozzle member 110 achieves sufficient sealing contact with the inner surface of the battery case 20, the electrolyte may be injected between the plurality of main ribs 120. In this case, a portion of the electrolyte may change its flow direction upon colliding with the plurality of main ribs 120, thereby enhancing uniform distribution throughout the entire internal region of the battery case 20.

The liquid injection device 100 according to the exemplary embodiment of the present disclosure achieves sealing contact by applying a radially outward pressing force to the inner surface of the battery case 20, so that the sealing force inside the battery case 20 may be secured without deforming the shape of the beading part 23 or altering the height of the battery case 20 during the liquid injection process.

Meanwhile, in the exemplary embodiment of the present disclosure, the liquid injection device 100 may further include a support plate 180 disposed along the inner circumference of the nozzle member 110 between the nozzle member 110 and the main rib 120. The support plate 180 may be disposed along the inner circumference of the nozzle member 110 to uniformly transmit the pressing force from the main rib 120 across the entire region of the nozzle member 110.

For example, a plurality of support plates 180 may be provided. The plurality of support plates 180 may become spaced apart from one another as the nozzle member 110 presses against the inner side wall 21 of the battery case 20 (e.g., see FIG. 6(b)). The support plates 180 described herein may be applied to all embodiments of the present disclosure.

The liquid injection device 100 may further include an actuator and a controller that controls the operation of the actuator. The actuator may be connected to the elevating member 130 to enable vertical movement of the elevating member 130. The controller may drive and control the actuator to move the elevating member 130 up and down. For example, the controller may control the elevating member 130 to move up and down based on a preset height. Alternatively, the controller may control the nozzle member 110 to press against the battery case 20 based on a predetermined pressure.

Hereinafter, the liquid injection device 100 according to various embodiments of the present disclosure will be described in detail with reference to the accompanying drawings. The embodiments described below are basically the same as the above-described embodiment in that they secure sealing force by pressing the inner surface of the battery case 20 outward in the radial direction through the nozzle member 110, but there are some structural and operational differences in the main rib 120.

Hereinafter, the liquid injection device 100 according to an exemplary embodiment of the invention will be specifically described, with emphasis on the differences from the previously described embodiment.

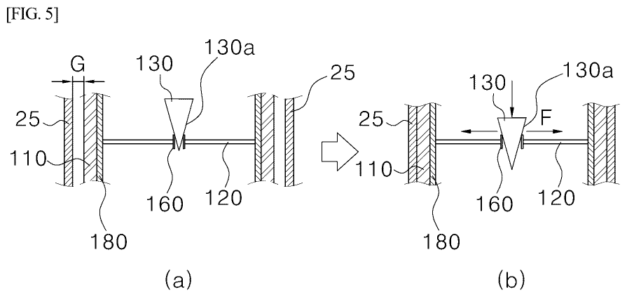

FIG. 5 is a cross-sectional view schematically illustrating the pressing process of the battery case 20 by a liquid injection device 100 according to an exemplary embodiment of the present disclosure, and FIG. 6 is a plan view illustrating the pressing process shown in FIG. 5 as viewed from above.

Referring to FIG. 5 and FIG. 6, the liquid injection device 100 according to an exemplary embodiment of the present disclosure may include a nozzle member 110, a main rib 120, and an elevating member 130. In addition, in the present embodiment, the liquid injection device 100 may further include a diameter-regulating member 160.

In the exemplary embodiment, the main rib 120 may be disposed to extend transversely to the axial direction when viewed from the side surface of the secondary battery 1. The main rib 120 may be moved in a radial direction. The main rib 120 may apply a pressing force to the nozzle member 110 by moving along the radial direction. For example, the main rib 120 may move radially inward or outward as its inner end slides along the outer circumferential surface of the elevating member 130 during the vertical movement of the elevating member 130.

The elevating member 130 may be disposed at the central part of the main ribs 120, which are disposed radially. The elevating member may have a conical shape. For example, the elevating member 130 may have a conical shape with a larger diameter at the top and a smaller diameter at the bottom. For example, as shown in FIG. 5(b), the elevating member 130 may include an inclined surface 130a formed on an outer circumferential surface when viewed from the side surface of the secondary battery 1.

The outer circumferential surface of the elevating member 130 may be slidably engaged with the inner end of the main rib 120. While the elevating member 130 moves up and down, the inner end of the main rib 120 may slide along the inclined surface 130a formed on the outer circumferential surface of the elevating member 130.

For example, the outer circumferential surface of the elevating member 130 may be slidably engaged with the inner end of the main rib 120 via the diameter-regulating member 160 described below. At least a portion of the inner circumferential surface of the diameter-regulating member 160 may be in contact with and slide along the outer circumferential surface of the elevating member 130 while the elevating member 130 moves up and down.

In an exemplary embodiment, the liquid injection device 100 may further include the diameter-regulating member 160, which is connected to the inner end of the main rib 120 and whose diameter is adjusted in response to the vertical movement of the elevating member 130. For example, the diameter-regulating member 160 may have a cylindrical shape with a hollow portion 160a formed in a radially central part, as shown in FIG. 6. The elevating member 130 may be disposed in the hollow portion of the diameter-regulating member 160. At least a portion of the inner circumferential surface of the diameter-regulating member 160 may contact and slide along the outer circumferential surface of the elevating member 130.

The diameter-regulating member 160 may include an elastic material. The diameter-regulating member 160 may be elastically deformed in response to the vertical movement of the elevating member 130. The diameter-regulating member 160 may be elastically deformed so that the inner diameter of the hollow portion expands or contracts in response to the vertical movement of the elevating member 130.

Referring to FIG. 5(a), in the initial state, the main rib 120 may be disposed at a first position parallel to the radial direction. In this case, the nozzle member 110, located at the outer end of the main rib 120, may have a diameter smaller than that of the injection port to facilitate insertion into the injection port.

Thereafter, when the cone-shaped elevating member 130 is moved up and down by the actuator, the inner circumferential surface of the diameter-regulating member 160 may slide along the outer circumferential surface of the elevating member 130. In this case, the inner diameter of the diameter-regulating member 160 may be elastically deformed to conform to the outer diameter of the elevating member 130 in contact. As the diameter-regulating member 160 is elastically deformed to increase or decrease its diameter, the radial position of the main rib 120 may be moved.

Referring to FIG. 5(b), the elevating member 130 is formed to have a larger diameter at the top and a smaller diameter at the bottom, and as the elevating member 130 moves downward, the diameter-regulating member 160 is elastically deformed to increase its diameter, and the position of the main rib 120 may be shifted outward along the radial direction.

Conversely, as the elevating member 130 moves upward, the diameter of the diameter-regulating member 160 elastically recovers to its original shape, and the position of the main rib 120 may be shifted inward in the radial direction.

However, it is not limited thereto, and the elevating member 130 may be formed in a conical shape with a larger diameter at the bottom and a smaller diameter at the top. In this case, the position of the main rib 120 may also be shifted by controlling the position of the elevating member 130, in contrast to the above-described case.

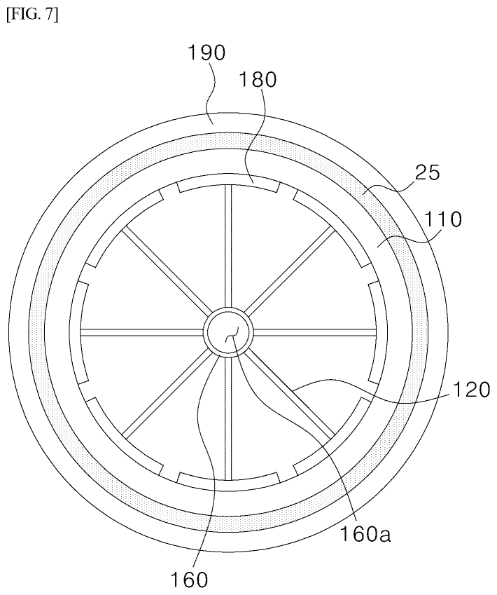

FIG. 7 is a plan view schematically illustrating a pressurized state of the battery case 20 caused by the liquid injection device 100 according to an exemplary embodiment of the present disclosure, viewed from above.

Referring to FIG. 7, the liquid injection device 100 may further include a reinforcing frame 190 disposed on the outer surface of the battery case 20 at a position corresponding to the nozzle member 110.

The reinforcing frame 190 may be disposed along the periphery of the battery case 20. The reinforcing frame 190 may support the battery case 20 from the outside of the battery case 20 in response to the pressing force applied radially outward from the nozzle member 110 to the inner surface of the battery case 20. The reinforcing frame 190 may prevent deformation of the battery case 20 due to the pressing force of the nozzle member 110.

It will be apparent that the above-described reinforcing frame 190 may be applied to all of the various embodiments proposed in the present disclosure.

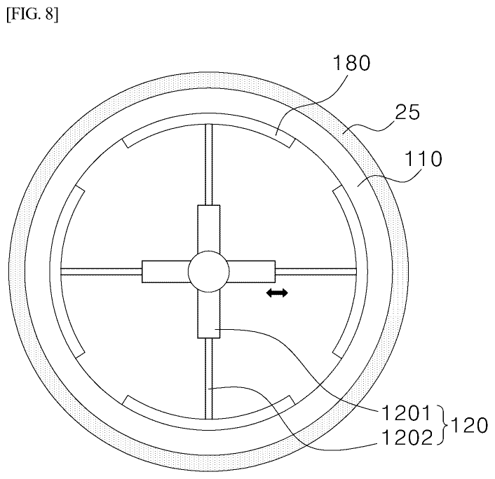

FIG. 8 is a plan view schematically illustrating a pressurized state of the battery case 20 caused by a liquid injection device 100 according to an exemplary embodiment of the present disclosure as viewed from above.

Referring to FIG. 8, the liquid injection device 100 according to an exemplary embodiment of the present disclosure may include a nozzle member 110 and a main rib 120. In the present embodiment, the main rib 120 may be driven by an actuator, and the elevating member 130 may be omitted.

In the exemplary embodiment, the main rib 120 may be disposed perpendicularly to the axial direction. The main rib 120 may be configured to have an adjustable length in the radial direction (e.g., see the arrow in FIG. 8). The main rib 120 may be configured to shorten or extend in length.

For example, the main rib 120 may include a first rib 1201 and a second rib 1202, of which at least a partial portion can be inserted into the first rib 1201. For instance, the main rib 120 may be configured to have an adjustable length by allowing at least a partial portion of the second rib 1202 to be inserted into or extended from the first rib 1201 according to the operation of the actuator.

The liquid injection device 100 may include an actuator that changes the length of the main rib 120 during operation. The actuator may include a hydraulic cylinder or a servo motor, and various known driving methods may be applied.

For example, the controller may control the actuator to shorten or extend the length of the main rib 120, thereby elastically deforming the nozzle member 110. The controller may control the length of the main rib 120 based on a preset value, or alternatively, based on the pressure applied by the nozzle member 110 to the inner surface of the battery case 20, but it is not limited thereto.

In the initial state, the actuator may be driven to shorten the length of the main rib 120, allowing the nozzle member 110 to be inserted into the injection port in a state spaced from the inner surface of the battery can.

Thereafter, the actuator may be driven to extend the length of the main rib 120, and the nozzle member 110 may be elastically deformed in a direction of increasing diameter by the pressing force provided by the main rib 120. The nozzle member 110 may be elastically deformed to have a diameter corresponding to that of the injection port of the battery case 20, thereby coming into close contact with the inner surface of the battery case 20. Additionally, once in contact with the inner surface of the battery case 20, the nozzle member 110 may be pressed into closer contact with the inner surface of the battery case 20 as the main rib 120 is further extended.

In this embodiment, the liquid injection device 100 may press the nozzle member 110 through a simple driving method, thereby enabling a reduction in manufacturing costs, and may improve process efficiency by easily controlling the length of the main rib 120.

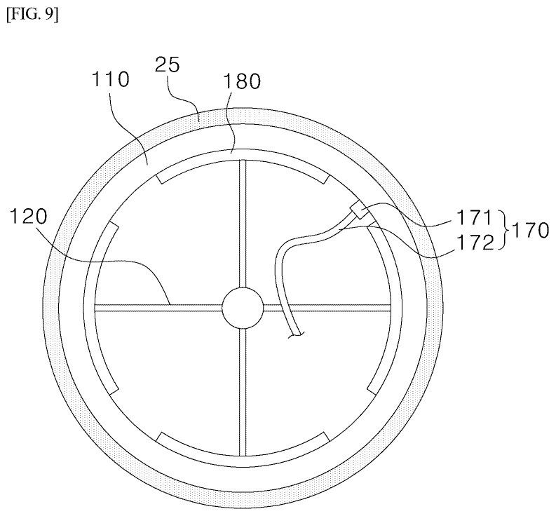

FIG. 9 is a plan view schematically illustrating a pressurized state of the battery case 20 caused by a liquid injection device 100 according to an exemplary embodiment of the present disclosure, as viewed from above.

Referring to FIG. 9, the liquid injection device 100 according to an exemplary embodiment of the present disclosure may include a nozzle member 110, a main rib 120, and a fluid injection member 170. In the present embodiment, the elevating member 130 may be omitted, and the volume of the nozzle member 110 may be expanded by the fluid injection member 170 driven by an actuator, thereby pressing the battery case 20.

In the exemplary embodiment, the nozzle member 110 may be provided in a tube shape having a fluid receiving space formed inside. The volume of the nozzle member 110 may change depending on the volume of fluid received in the fluid receiving space.

In the exemplary embodiment, the liquid injection device 100 may further include the fluid injection member 170 capable of injecting fluid into the fluid receiving space of the nozzle member 110. The fluid injection member 170 may further include a fluid injection port 171 disposed on one side of the nozzle member 110 through which fluid is injected into the interior of the nozzle member 110, and a fluid supply pipe 172 connected to the fluid injection port 171 to supply the fluid.

For example, in the initial state, the nozzle member 110 may be in a state where no fluid is injected or only a small amount of fluid is injected inside, and its volume may be contracted, and may be inserted in a state separated from the inner surface of the injection port by a predetermined gap (e.g., G of FIG. 4).

Thereafter, when the fluid supplied through the fluid supply pipe 172 is injected into the nozzle member 110 through the fluid injection port 171 by an operation of the actuator, the volume of the nozzle member 110 may be expanded. The nozzle member 110 may press the inner surface of the battery case 20 by expanding its volume in response to the fluid injection.

In this case, air or oil may be used as the fluid, but it is not limited thereto, and any fluid that can be injected into the inside of the nozzle member 110 to expand its volume may be used.

For example, the controller may control the volume of the nozzle member 110 based on a preset injection amount of fluid, or alternatively, based on the pressure applied by the nozzle member 110 to the inner surface of the battery case 20, but it is not limited thereto.

In this embodiment, the liquid injection device 100 may press the nozzle member 110 through a simple driving method to bring it into close contact with the inner surface of the battery case 20, which may be advantageous in terms of reducing the manufacturing costs.

In the above, various exemplary embodiments have been described in which adhesion force may be improved by pressing the inner surface of the battery case 20 radially outward using the injection nozzle disposed at the injection port of the battery case 20 in the liquid injection device 100 according to various embodiments of the present disclosure.

In the liquid injection device 100 according to various embodiments of the present disclosure described above, the exemplary embodiments regarding the pressurization method for the battery case 20 through the nozzle member 110 do not preclude application to other embodiments, and it should be understood that all components proposed in each embodiment, within the scope and objectives of the present disclosure, may be selectively combined in one or more configurations, and may be applied to or integrated with other embodiments at least partially.

As described above, the liquid injection device 100 according to various embodiments of the present disclosure may improve the sealing force inside the battery case 20 during the electrolyte injection.

In addition, the liquid injection device 100 according to various embodiments of the present disclosure may prevent the deformation of the battery case 20 during the electrolyte injection.

Further, the liquid injection device 100 according to various embodiments of the present disclosure may prevent the deformation of the battery case 20, thereby facilitating the securing of the external design dimensions of the final cell.

Furthermore, the liquid injection device 100 according to various embodiments of the present disclosure may minimize the external force applied to the beading part 23 of the battery case 20 during the electrolyte injection process, thereby minimizing the influence on the subsequent crimping process and stabilizing the manufacturing process of the secondary battery 1.

The contents described above are merely examples of applying the principles of the present disclosure, and other configurations may be further included without departing from the scope of the present disclosure.

What is claimed is:

1. A liquid injection device configured to inject an electrolyte into a battery case of a secondary battery, the liquid injection device comprising:
a nozzle member having a closed-loop shape and disposed in the injection port of the battery case; and
a main rib extending from the nozzle member toward a central part of the nozzle member to support the nozzle member,
wherein the nozzle member is configured to press the inner surface of the battery case outward in a radial direction.

2. The liquid injection device according to claim 1, wherein the nozzle member closely supports the inner surface of the battery case outward in the radial direction.

3. The liquid injection device according to claim 1, wherein the nozzle member is located above a beading part of the battery case.

4. The liquid injection device according to claim 1, wherein the nozzle member is disposed at a position corresponding to a crimping part of the battery case.

5. The liquid injection device according to claim 1, wherein the nozzle member is located above an electrode assembly disposed inside the battery case.

6. The liquid injection device according to claim 1, wherein the nozzle member comprises an elastic material.

7. The liquid injection device according to claim 1, further comprising an elevating member disposed to move up and down at the central part of the nozzle member,
wherein a longitudinal inner end of the main rib is configured to move along an outer circumferential surface of the elevating member.

8. The liquid injection device according to claim 7, wherein the main rib applies a pressing force to the nozzle member by changing its angle with respect to the nozzle member.

9. The liquid injection device according to claim 7,
further comprising an auxiliary rib connecting the elevating member and the main rib,
wherein the longitudinal inner end of the auxiliary rib is connected to the elevating member, and
a longitudinal outer end of the auxiliary rib is connected to the main rib.

10. The liquid injection device according to claim 7, further comprising a bushing member connected to the longitudinal inner end of the main rib to guide a vertical movement of the elevating member.

11. The liquid injection device according to claim 10, wherein the longitudinal inner end of the main rib is fixed to one side of the elevating member through the bushing member.

12. The liquid injection device according to claim 7, wherein the elevating member has a columnar shape extending in the axial direction.

13. The liquid injection device according to claim 7, wherein the main rib applies a pressing force to the nozzle member by shifting its position in the radial direction.

14. The liquid injection device according to claim 11, wherein the elevating member is formed in a conical shape.

15. The liquid injection device according to claim 14, further comprising a diameter-regulating member connected to the inner end of the main rib and having a diameter which is adjusted in response to the vertical movement of the elevating member.

16. The liquid injection device according to claim 7, wherein the length of the main rib is adjustable in the radial direction.

17. The liquid injection device according to claim 1, wherein the nozzle member has a tube shape configured to inject a fluid, and
the nozzle member expands in volume in response to the injection of the fluid to press the inner surface of the battery case.

18. The liquid injection device according to claim 17, further comprising a fluid injection port disposed on one side of the nozzle member through which the fluid is injected.

19. The liquid injection device according to claim 1, further comprising a support plate disposed along an inner circumference of the nozzle member between the nozzle member and the main rib.

20. The liquid injection device according to claim 19, wherein a plurality of support plates are provided, and the plurality of support plates are spaced apart from one another as the nozzle member presses the inner wall of the battery case.
